(19) United States
(12) Patent Application Publication
(10) Pub. No.: US 2010/0140065 A1
(43) Pub. Date: Jun. 10, 2010

(54) Multi-step pressurized switch

(75) Inventor: Geun Ju Lee, Anyangsi (KR)

Correspondence Address: FARJAMI & FARJAMI LLP, 26522 LA ALAMEDA AVENUE, SUITE 360, MISSION VIEJO, CA, 92691, US

(73) Assignee: Hanbit Precision Co., Ltd. (Republic of Korea)

(21) Appl. No.: 12/587,636

(22) Filed: Oct. 8, 2009

(30) Foreign Application Priority Data
Dec. 8, 2008 (KR) 10-2008-0124217
Jan. 8, 2009 (KR) 10-2009-0001478
Jan. 14, 2009 (KR) 10-2009-0002993
Sep. 3, 2009 (KR) 10-2009-0082826

(51) Int. Cl. H01H 1/10

(52) U.S. Cl. 200/17 R; 200/512

(57) ABSTRACT

Disclosed is a multi-step pressurized switch providing various signals in response to variation of pressure applied thereto. The multi-step pressurized switch includes a switched PCB connected to a PCB of an electronic device and having at least one or more contact points on the top, and an elastic plate settled on the top of the switched PCB and electrically connecting the contact points with each other if there is pressure. The elastic plate includes a first projection protruding upward from the edge of the elastic plate, a second projection joining with the first projection and protruding in the same direction with the first projection, and a first slope bending down toward a direction opposite to the first projection from the edge of the elastic plate.

### CROSS-REFERENCE TO RELATED APPLICATION

This application is based on and claims priority from Korean Patent Application Nos. 10-2008-0124217, 10-2009-0001478, 10-2009-0002993 and 10-2009-0082826 filed on Dec. 8, 2008, Jan. 8, 2009, Jan. 14, 2009 and Sep. 3, 2009, respectively in the Korean Intellectual Property Office, the disclosure of which is incorporated herein in its entirety by reference.

### BACKGROUND OF THE INVENTION

1. Field of the Invention

Exemplary embodiments relate generally to pressurized switches capable of providing different signals variable by pressure applied thereto.

2. Description of the Prior Art

A pressurized switch, having a conductor that operates by moving up and down between contact points separated from each other, is generally used for controlling an on/off operation of a system since it generates just a single signal by contacting the conductor between the contact points.

In recent years, with the trends toward the scaling-down of household electrical appliances and the convenience for users, there have been proposed pressurized switches capable of generating various signals in response to pressure variation.

Those pressurized switches operating in the pressure mode are fabricated to generate various patterns of signals by shifting contact points in response to pressure applied thereto. In such a pressurized switch, a number of contact points are disposed to move their contacting positions by means of an elastic plate that is changed in shape when pressure is applied thereto.

However, such pressurized switches are usually formed by fixing the elastic plates to printed circuit boards (PCB) in a form of reclamation, so it makes their fabrication processes complicated.

Further, as signals from the pressurized switch are variously generated by a turnover operation of the elastic plate, it degrades quick response character because there is a need of finely adjusting pressure to the switch around an area at which a turnover transformation occurs in the elastic plate.

### SUMMARY OF THE INVENTION

Accordingly, the exemplary embodiments have been made to solve the above-mentioned problems occurring in the prior art while advantages achieved by the prior art are maintained intact.

The exemplary embodiments are directed to a multi-step pressurized switch fabricated with a simpler PCB structure in a lower product cost.

The exemplary embodiments are also directed to a multi-step pressurized switch quickly responding to pressure by a user, including a space that enables vertical motion to a direction of pressure transmission.

The exemplary embodiments are further directed to a multi-step pressurized switch responding to a minute pressure variation.

The exemplary embodiments are further directed to a multi-step pressurized switch capable of shielding itself from electromagnetic waves by means of an electromagnetic interference shielding film.

The exemplary embodiments are further directed to a multi-step pressurized switch fabricated by a simpler process.

The exemplary embodiments are further directed to a multi-step pressurized switch improved in a sense of click.

The exemplary embodiments are further directed to a multi-step pressurized switch capable of enabling a multi-step operation only by a single elastic plate.

In an embodiment, there is provided a multi-step pressurized switch including: a switched PCB connected to a PCB of an electronic device and having at least one or more contact points on the top; and an elastic plate settled on the top of the switched PCB and electrically connecting the contact points with each other if there is pressure. The elastic plate may include: a first projection protruding upward from the edge of the elastic plate; a second projection joining with the first projection and protruding in the same direction with the first projection; and a first slope bending down toward a direction opposite to the first projection from the edge of the elastic plate.

The first projection may include a cutout space facilitating transformation of the first projection if the elastic plate is pressed. The first and second projections may be configured to slant toward the center of the elastic plate. The elastic plate may further include a second slope disposed between the first and second projections and isolating the first and second projections. The switched PCB may include: a first contact point having a margin from the first slope under the elastic plate; a second contact point meeting the first projection if the elastic plate is pressed; and a third contact point meeting the second projection if the elastic plate is more pressed than when the first projection meets the second contact point.

The multi-step pressurized switch may further include a film wrapping the elastic plate and the switched PCB and fixing the elastic plate to the switched PCB. The film may be an electromagnetic interference shielding film.

The first slope may be configured to have a plurality of bridges opposite to each other at both corners of the elastic plate.

The bridges may be composed of two members opposite to each other, or four members opposite to each other in diagonals.

In another embodiment, a multi-step pressurized switch may include: a PCB on which a plurality of contact parts is formed; and an elastic plate settled on the PCB and electrically connecting the contact parts of the PCB. The elastic plate may include: a base fixedly settled on the PCB and shaped in a belt slanting outward; a first contact region disposed in both internal sides of the base and extending toward the center of the base; a second contact region configured in a convex at the center of the base; and connectors linking the first and second contact regions together. In this embodiment, the first contact region meets the contact part of the PCB if the second contact region is pressed and then the second contact region meets the contact part of the PCB if the second contact region is continuously pressed.

The PCB may further include: a frame in which grooves are formed in a predetermined shape; and conductive terminals configured corresponding to the grooves and fixedly inserted into the grooves to form the plural contact parts.

The base may include bends formed at the left and right sides and steadily meeting the contact part of the PCB.

The PCB may further include grooves at both sides. And, the base may include hooks provided at both ends and fixedly inserted into the grooves of the PCB.

The multi-step pressurized switch may further include a protection film attached to wrap the top of the elastic plate and fixing the elastic plate on the PCB. In this case, the multi-step pressurized switch may further include a frame cover settled on the protection film and combined to the PCB through both ends, preventing the elastic plate and the protection film from separation.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a multi-step pressurized switch according to an embodiment of the present invention;

FIG. 2 is a divisional perspective view of the multi-step pressurized switch shown in FIG. 1;

FIGS. 3A through 3C are operational views of the multi-step pressurized switch shown in FIG. 1;

FIGS. 4A and 4B are plan views illustrating other patterns of the elastic plate shown in FIG. 1;

FIG. 5 is a perspective view illustrating a multi-step pressurized switch according to another embodiment of the present invention;

FIG. 6 is a divisional perspective view of the multi-step pressurized switch shown in FIG. 5; and

FIGS. 7A through 7C are operational views of the multi-step pressurized switch shown in FIG. 5.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto. The same drawing reference numerals are used for the same elements across various figures.

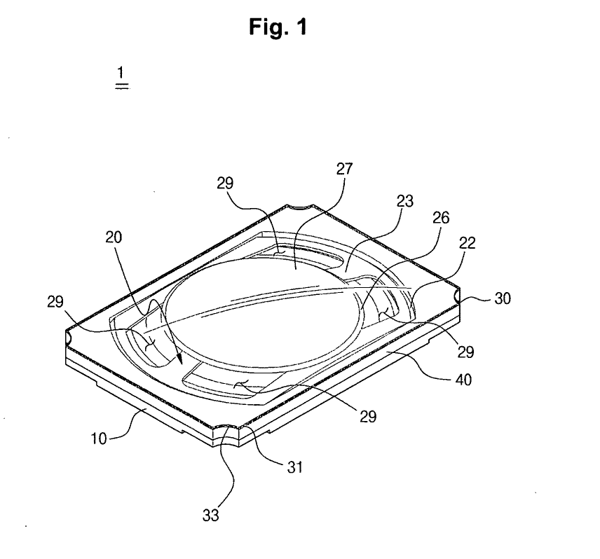

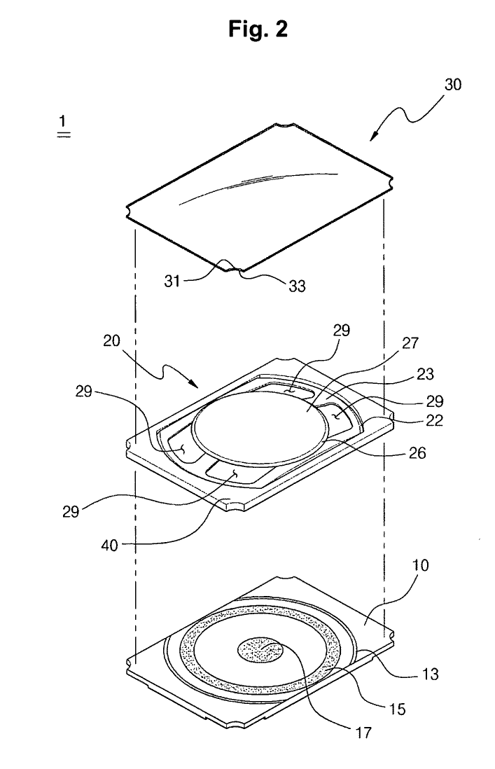

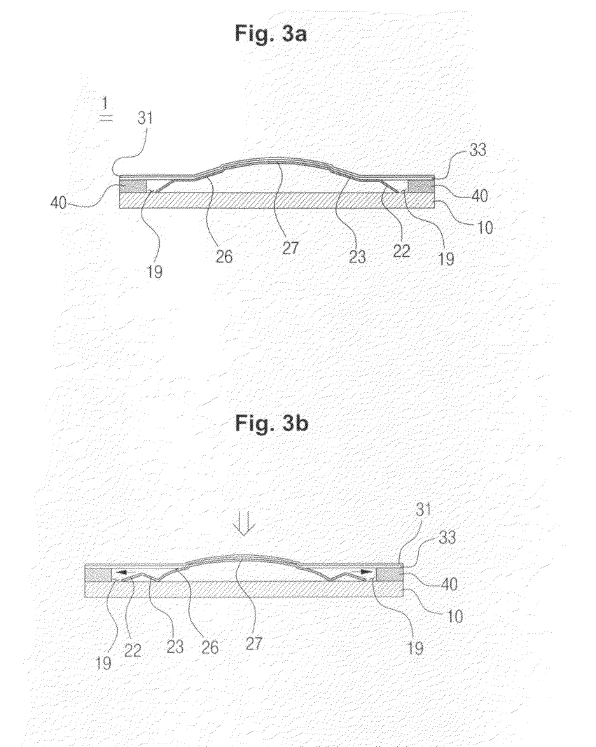

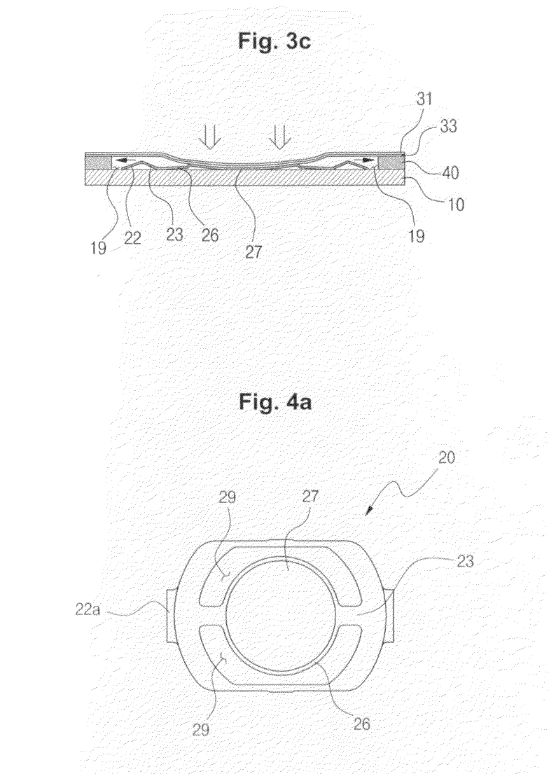

FIG. 1 perspectively shows a multi-step pressurized switch according to a preferred embodiment of the present invention and FIG. 2 divisionally shows the multi-step pressurized switch shown in FIG. 1. And, FIGS. 3A through 3C show an operational feature of the multi-step pressurized switch shown in FIG. 1.

Referring to FIGS. 1 through 3C, the multi-step pressurized switch 1 may be comprised of an elastic plate 20, a switched printed circuit board (hereinafter, referred to as “switched PCB”) 10 on which contact points 12, 15 and 17 are placed, and a film 30 wrapping the tops of the elastic plate 20 and the switched PCB 10.

The elastic plate 20 is laid on the top of the switched PCB 10. In operation, being pressed down by a user, the elastic plate 20 meets the contact points 13, 15 or 17 on the switched

PCB. But, without pressure thereto, the elastic plate 20 is isolated from the contact points 13, 15 or 17, returning to its original form.

As illustrated in FIG. 2, the elastic plate 20 is composed of a first slope 22 bending down toward the switched PCB 10 from the edge of the elastic plate 20, a first projection 23 protruding upward and having a slant to the center of the elastic plate 20, a second slope 26 ascending toward the center of the elastic plate 20 and joining with the first projection 23, and a second projection 27 protruding upward from the second slope 26.

The first slope 22 is placed to meet the first contact point 13 on the switched PCB 10 when pressure is applied to the elastic plate 20 by a user. As shown by the vertical sections in FIGS. 3A through 3C, the first slope 22 goes down from the first projection 23 so as to have a slant to the switched PCB 10.

The first projection 23 is placed to meet the second contact point 15 on the switched PCB 10 when pressure is applied to the elastic plate 20 by a user. As shown by the vertical sections in FIGS. 3A through 3C, the first projection 23 is shaped as a plate, in which both ends are rounded and the center is protruded upward.

As shown in FIGS. 1 and 2, in the first projection 23, a cutout space 29 is provided to open through the top and bottom thereof. The cutout space 29 enables the first projection 23 to be easily transformed to contact with the second contact point 15 when a user presses the elastic plate 20.

The second slope 26 is configured to have a hoop shape slanting toward the center of the elastic plate 20 at the center of the first projection 23.

The second slope 26 is provided to isolate the first projection 23 from the second projection 27. When a user presses the elastic plate 20, the second projection 27 transforms to be leveled lower than the first projection 23 or in the same position with the first projection 23, preventing the first and second projections 23 and 27 from contacting each other.

The second projection 27 joining with the second slope 26 is shaped in a round plate having a convex surface. With this structure, the second projection 27 meets the third contact point 17 if the first projection 23 begins to be transformed and the elastic plate 20 is pressed heavier than when the first projection 23 has met the second contact point 15.

Additionally, on the bottom of the switched PCB 10, other contact points (not shown; referred to as “bottom contact points”) are formed to meet a PCB of a mobile communication terminal. The first, second and third contact points, 13, 15 and 17, which are arranged on the top of the switched PCB 10, are electrically connected to the bottom contact points (i.e., the first through third contact points may be electrically connected to the PCB of the mobile communication terminal through the bottom contact points of the switched PCB 10). The elastic plate 20 is laid on the contact points 13, 15 and 17.

Additionally, On the top of the switched PCB 10, a base film 40 having an opening shaped as like the elastic plate 20 is further comprised to prevent the elastic plate 20 from sliding and moving out of the switched PCB 10.

The base film 40 is made of polyethylene terephthalate (PET) or polycarbonate (PC).

Between the base film 40 and the elastic plate 20, as shown in FIGS. 3A through 3C, a space 19 is formed to permit the elastic plate 20 to move along the top of the switched PCB 10 while the elastic plate 20 is transforming. The tops of the elastic plate 20 and the base film 40 are fixedly wrapped in the film 30.

The space 19 is a spatial room for enabling the elastic plate 20 to extend laterally while the elastic plate 20 is transforming. With the space 19, the elastic plate 20 can be easily transformed by pressure applied thereto.

The first contact point 13, the second contact point 15 and the third contact point 17 are arranged on the top of the switched PCB 10 and electrically connected to the bottom contact points formed on the bottom of the switched PCB 10.

As shown in FIG. 2, the first contact point 13 is disposed in correspondence with a location of the first slope 22 and the second contact point 15 is designed to accord with a pattern of the first projection 23. The third contact point 17 is shaped in a circle and disposed corresponding to a location of the second projection 27 so as to meet the second projection 27 when the elastic plate 20 is pressed by a user.

The film 30 wrapping the tops of the elastic plate 20 and the base film 40 is made up of an electromagnetic interference shielding film 31 for the purpose of blocking electromagnetic waves from a mobile communication terminal.

In this structure, an insulation film made of an insulator, such as polyethylene terephthalate (PET), is formed on the bottom of the electromagnetic interference shielding film 31, interrupting electrical conduction to the top of the elastic plate 20.

Now, phased operations of the multi-step pressurized switch 1 will be described hereinafter with reference to FIGS. 3A through 3C.

FIG. 3A shows an initial step when there is no pressure to the elastic plate 20, in which the end of the first slope 22 meet only the first contact point 13.

From the initial step, if a user presses the elastic plate 20, the elastic plate 20 is transformed as like as shown in FIG. 3B and the first projection 23 meet the second contact point 15. Thereby, the first contact point 13 is electrically connected to the second contact point 15 through the elastic plate 20.

In other words, being pressed by a user, as shown in FIG. 3B, the elastic plate 20 is transformed to become wider into the space 19 toward the base film 30 and hence the first projection 23 meet the second contact point 15.

From the step shown in FIG. 3B, if the elastic plate 20 is continuously pressed by the user in a heavier strength than that of FIG. 3B, it is more transformed to further extend into the space 19 and the second projection 23 meet the third contact point 17 as noticed by FIG. 3C.

At this time, the second projection 27 is turned over to reduce the repulsive force thereof as illustrated in FIG. 3C, giving the user a sense of click.

As aforementioned, since the multi-step pressurized switch 1 is simply composed of the switched PCB 10, the elastic plate 20 and the film 30, it is possible to scale down the switch 1 in size, especially in height. Thus, the multi-step pressurized switch 1 according to the exemplary embodiments may be advantageously applicable to a smallized device such as mobile communication terminal.

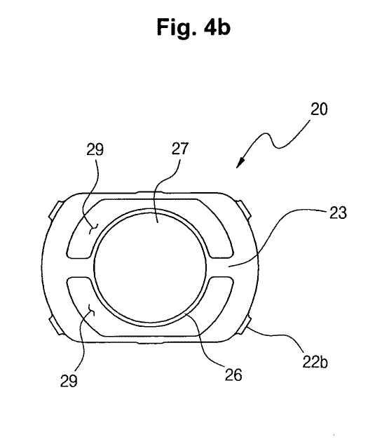

In the meantime, FIGS. 4A and 4B show other embodiments according to the present invention, illustrating other available patterns relevant to the elastic plate 20.

The components or elements with the reference numerals marked in FIGS. 4A and 4B, but omitted from the following description, may be understood by referring to the aforementioned explanation.

In these embodiments, the first slope 22 of the elastic plate 20 is composed of bridges 22a and 22b as respectively shown in FIGS. 4A and 4B. The bridges 22a or 22b are formed with in plurality, confronting to each other at both sides or around the corners of the elastic plate 20.

Referring to FIG. 4A, a pair of the bridges 22a is arranged at both sides of the elastic plate 20, in which the two bridges confront each other. Referring to FIG. 4B, the four bridges 22b are disposed to confront each other diagonally.

Owing to these structure of the first slope 22 with the bridges 22a or 22b, it contributes to enhance a sense of click for a user. And, as the contacting force by pressure is concentrated on the bottoms of the bridges 22a or 22b, it also improves the reliability of contacts.

Moreover, it is possible to lighten the elastic plate 20, reducing the total weight of the multi-step pressurized switch according to the exemplary embodiment of the present invention.

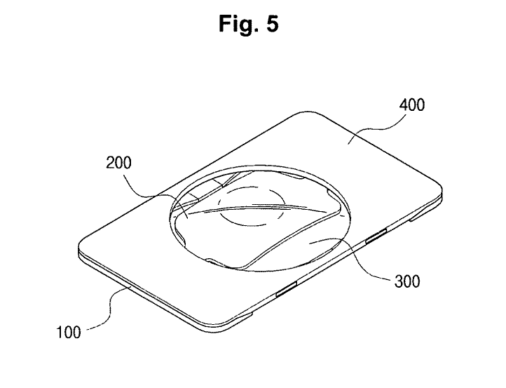

Now further will described other embodiments proposed by the present invention for the multi-step pressurized switch in conjunction with FIGS. 5 through 7C.

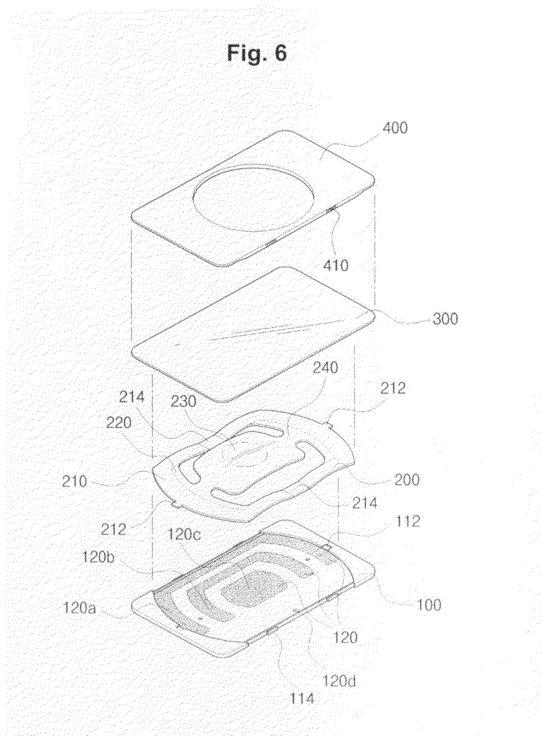

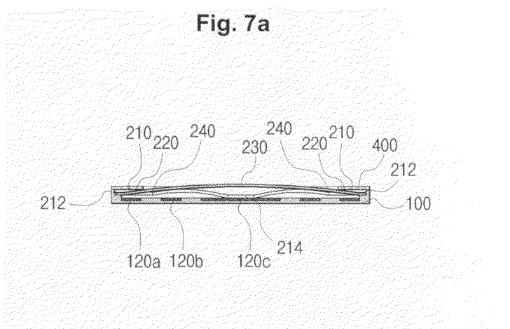

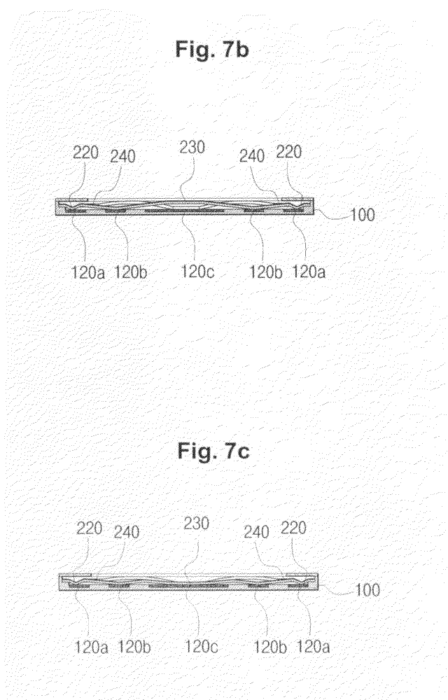

FIG. 5 illustrates a perspective of the multi-step pressurized switch according to another embodiment of the present invention and FIG. 6 illustrates a divisional perspective of the multi-step pressurized switch shown in FIG. 5. And FIGS. 7A through 7C show an operational flow of the multi-step pressurized switch shown in FIG. 5.

Referring to FIGS. 5 through 7C, the multi-step pressurized switch may be comprised of a printed circuit board (PCB) 100, an elastic plate 200, a protection film 300 and a frame cover 400. The PCB 100, the elastic plate 200, the protection film 300 and the frame cover 400 are sequentially stacked to form the in this order from the bottom.

On the PCB 100, as noticed from FIGS. 6 through 7C, a plurality of contact parts is provided with isolation from each other. In this embodiment, the contact parts are exemplarily arranged in four members, e.g., 120a, 120b, 120c and 120d, on the PCB 100.

The PCB 100, as shown in FIG. 6, may be configured to include a frame 110 and conductive terminals 120. The frame 110 has a plurality of grooves that are shaped in a predetermined pattern. The conductive terminals 120 are inserted into the grooves of the frame 110. The contact parts 120a˜120d are completed by fixedly settling the terminals 120 in the grooves of the frame 110. For convenience of description, 120a, 120b, 120c and 120d are referred hereinafter to as the first, second, third and fourth contact parts of the PCB 100.

The frame 110 and the conductive terminals 120 of the PCB 100 may be manufactured by an insert molding process.

The elastic plate 200 is combined with the top face of the PCB 100, operating to conduct an electrical connection between the contact parts 120a˜120d of the PCB if it is pressed. The elastic plate 200 is made up of a conductive material. If pressure is removed, the elastic plate 200 is isolated from the contact parts and returns to its original form.

The elastic plate 200 is fixedly settled on the PCB 100. The elastic plate 200 may be composed of a base 210 shaped in a belt slanting outward, a first contact region 220 extending toward the center of the base 210 from both side of the base 210, a second contact region 230 formed in a convex at the center of the base 210, and connectors 240 linking the first and second contact regions 220 and 230 together.

In this embodiment, the base 210 is configured to have a slant rising toward the center. At both ends of the base 210, hooks 212 are provided to be inserted into the grooves that are formed in the both ends of the frame 110 of the PCB 100. The reason of providing the grooves 112 and the hooks 212 is for making the base 210 easily combined to the PCB, which simplifies the fabrication process of the multi-step pressurized switch.

At the left and right sides of the base 210, bends 214 are formed to continuously meet the contact parts of the PCB 100. For instance, the bends 214 formed at the left and right sides of the base 210 are steadily conditioned to respectively meet the first and fourth contact parts 120a and 120d of the PCB 100. These bends 214 contribute to stably support the elastic plate 200 on the PCB 100, enhancing the first clicking performance thereof.

The first contact region 220 goes down to meet the first contact part 120a of the PCB 100 when the elastic plate 200 is pressed. The first contact region 220 is formed to extend toward the center from both internal sides of the base 210, which may be configured horizontally or slantingly. The first contact region 220 of the elastic plate 200 can be noticed by the dotted line in FIG. 6.

The connectors 240 acts to link the first and second contact regions 220 and 230 together, which may be configured horizontally or slantingly as like the first contact region 220.

The second contact region 230 is configured in a convex to which pressure is directly applied. If pressure is applied to the second contact region 230, the first contact region 220 first meets the first contact part 120a of the PCB 100 and the edge of the second contact region 230 meets the second contact part 120b of the PCB 100. Afterward, if the elastic plate 200 is continuously pressed, the center of the second contact region 230 goes down to meet the third contact part 120c of the PCB 100.

The protection film 300 is attached to wrap the top of the elastic plate 200, strongly fixing the elastic plate 200 to the PCB 100. While the elastic plate 200 is fixed to the PCB 100 by inserting the hooks 212, which join with both ends thereof, into the grooves 112 at the both sides of the frame 110, the protection film 300 contributes to more strengthening the fixation force of the elastic plate 200 on the PCB 100. Furthermore, the protection film 300 is also helpful in protecting the elastic plate 200 from a physical or mechanical damage by frequent presses of a button to the second contact region 230. The protection film 300 may be formed of polyethylene terephthalate (PET).

The frame cover 400 is placed on the protection film 300 and combined with the PCB 100, acting to hold the elastic plate 200 and the protection film 300 within a boundary between the PCB 100 and the frame cover 400 and prevent them from being out of the boundary.

In combination between the frame cover 400 and the PCB 100, hooks 114 are formed on the edge of the PCB 100 and both sides of the frame cover 400 extends downward and have holes 410 which can be inserted by the hooks 114.

In case that the multi-step pressurized switch shown in FIGS. 5 through 7C is employed in an electronic device such as mobile communication terminal, the frame cover 400 is partly cut out to expose the second contact region 230 of the elastic plate 200 so as to make a button press the elastic plate 200.

Hereinafter will be described a fabrication procedure of the multi-step pressurized switch according to this embodiment.

First, the insert molding processes are carried out to independently form the PCB 100 including the frame 110 and the terminals 120, the elastic plate 200, the protection film 300 and the frame cover 400.

Then, the elastic plate 200 is fixed to the top of the PCB 100. During this, the hooks 212 at both ends of the elastic plate 200 are inserted into the grooves 112 formed at both sides of the frame 110. The bends 214 of the elastic plate 200 are set to steadily meet the first and fourth contact parts 120a and 120d of the PCB 100.

Next, the protection film 300 is attached to wrap the top of the elastic plate 200. During this, the corners of the protection film 300 are the upper side of the PCB 100 and thereby the elastic plate 200 is further fixed to the PCB 100.

Finally, by settling the frame cover 400 on the elastic plate 200, to which the protection film 300 is attached, and combining the frame 110 of the PCB 100 with the structure assembling the frame cover 400, the elastic plate 200 and the protection film 300, the multi-step pressurized switch is completely fabricated. As described above, the multi-step pressurized switch can be easily fabricated in a simple procedure.

With this structure, the multi-step pressurized switch shown in FIGS. 5 and 6 operates as follows as illustrated in FIGS. 7A through 7C.

First referring to FIG. 7A, unless there is no pressure to the elastic plate 200, the bends 214 of the elastic plate 200 are just meeting the first and fourth contact parts 120a and 120d.

From the state of FIG. 7A, if the second contact region 230 of the elastic plate 200 is pressed in a predetermined force as shown in FIG. 7B, the elastic plate 200 begins to be transformed. Then, the first contact region 220 linking to the second contact region 230 through the connectors 240 first meets the first contact part 120a of the PCB 100 and the edge of the second contact region 230 meets the second contact part 120b of the PCB 100. Thereby, the first contact part 120a, the fourth contact part 120d and the second contact part 120b are electrically connected together.

Now referring to FIG. 7C, being more pressed, the second contact region 230 of the elastic plate 200 is further transformed to dent toward the PCB 100. Thus, the center of the second contact region 230 entirely meets the third contact part 120c of the PCB 100, hence resulting in all electrical connections between the first through fourth contact parts 120a˜120d.

As described above, the multi-step pressurized switch according to the exemplary embodiments is effective in reducing a product cost in virtue of a simpler structure of an elastic plate and a switched PCB.

Further, if there is an input of pressure by a user, the multi-step pressurized switch according to the exemplary embodiments is improved in operational reliability by responding to a minute pressure variation, as well as quickly responding to a pressurized input, through a space that enables vertical motion against a direction of pressure transmission.

Further, the exemplary embodiments provide the multi-step pressurized switch with an electromagnetic interference shielding film that interrupts electromagnetic waves from electronic devices.

Besides, the multi-step pressurized switch can be fabricated in a smaller product cost by a simpler process of fixedly settling an elastic plate on a PCB, attaching a protection film and combining a frame cover thereto.

Further, it improves a sense of click since an elastic plate is provided with bends constantly meeting contact parts of a PCB.

Moreover, according to the exemplary embodiments, even a single elastic plate enables a multi-step operation because a plurality of contact regions of the elastic plate (e.g., 200) sequentially meets contact parts of a PCB when the elastic plate is pressed.

Although exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A multi-step pressurized switch, comprising:
a switched PCB connected to a PCB of an electronic device and having at least one or more contact points on the top; and
an elastic plate settled on the top of the switched PCB and electrically connecting the contact points with each other if there is pressure,
wherein the elastic plate comprises:
a first projection protruding upward from the edge of the elastic plate; a second projection joining with the first projection and protruding in the same direction with the first projection; and a first slope bending down toward a direction opposite to the first projection from the edge of the elastic plate.

2. The multi-step pressurized switch according to claim 1, wherein the first projection comprises: a cutout space facilitating transformation of the first projection if the elastic plate is pressed.

3. The multi-step pressurized switch according to claim 2, wherein the first and second projections are configured to slant toward the center of the elastic plate,
wherein the elastic plate further comprises: a second slope disposed between the first and second projections and isolating the first and second projections.

4. The multi-step pressurized switch according to claim 1, wherein the switched PCB comprises:
a first contact point having a margin from the first slope under the elastic plate; a second contact point meeting the first projection if the elastic plate is pressed; and a third contact point meeting the second projection if the elastic plate is more pressed than when the first projection meets the second contact point.

5. The multi-step pressurized switch according to claim 2, wherein the switched PCB comprises:
a first contact point having a margin from the first slope under the elastic plate; a second contact point meeting the first projection if the elastic plate is pressed; and a third contact point meeting the second projection if the elastic plate is more pressed than when the first projection meets the second contact point.

6. The multi-step pressurized switch according to claim 3, wherein the switched PCB comprises:
a first contact point having a margin from the first slope under the elastic plate; a second contact point meeting the first projection if the elastic plate is pressed; and a third contact point meeting the second projection if the elastic plate is more pressed than when the first projection meets the second contact point.

7. The multi-step pressurized switch according to claim 1, which further comprises: a film wrapping the elastic plate and the switched PCB and fixing the elastic plate to the switched PCB.

8. The multi-step pressurized switch according to claim 7, wherein the film is an electromagnetic interference shielding film.

9. The multi-step pressurized switch according to claim 1, wherein the first slope is configured to comprise a plurality of bridges opposite to each other at both corners of the elastic plate.

10. The multi-step pressurized switch according to claim 2, wherein the first slope is configured to comprise a plurality of bridges opposite to each other at both corners of the elastic plate.

11. The multi-step pressurized switch according to claim 3, wherein the first slope is configured to comprise a plurality of bridges opposite to each other at both corners of the elastic plate.

12. The multi-step pressurized switch according to claim 9, wherein the bridges are two members opposite to each other.

13. The multi-step pressurized switch according to claim 10, wherein the bridges are two members opposite to each other.

14. The multi-step pressurized switch according to claim 11, wherein the bridges are two members opposite to each other.

15. The multi-step pressurized switch according to claim 9, wherein the bridges are four members opposite to each other in diagonals.

16. The multi-step pressurized switch according to claim 10, wherein the bridges are four members opposite to each other in diagonals.

17. The multi-step pressurized switch according to claim 11, wherein the bridges are four members opposite to each other in diagonals.

18. A multi-step pressurized switch, comprising:
a PCB on which a plurality of contact parts is formed; and
an elastic plate settled on the PCB and electrically connecting the contact parts of the PCB,
wherein the elastic plate comprises:
a base fixedly settled on the PCB and shaped in a belt slanting outward; a first contact region disposed in both internal sides of the base and extending toward the center of the base; a second contact region configured in a convex at the center of the base; and connectors linking the first and second contact regions together,
wherein the first contact region meets the contact part of the PCB if the second contact region is pressed and then the second contact region meets the contact part of the PCB if the second contact region is continuously pressed.

19. The multi-step pressurized switch according to claim 18, wherein the PCB further comprises: a frame in which grooves are formed in a predetermined shape; and conductive terminals configured corresponding to the grooves and fixedly inserted into the grooves to form the plural contact parts.

20. The multi-step pressurized switch according to claim 18, wherein the base comprises: bends formed at the left and right sides and steadily meeting the contact part of the PCB.

21. The multi-step pressurized switch according to claim 18, wherein the PCB further comprises: grooves at both sides,
wherein the base comprises: hooks provided at both ends and fixedly inserted into the grooves of the PCB.

22. The multi-step pressurized switch according to claim 18, which further comprises: a protection film attached to wrap the top of the elastic plate and fixing the elastic plate on the PCB.

23. The multi-step pressurized switch according to claim 19, which further comprises: a protection film attached to wrap the top of the elastic plate and fixing the elastic plate on the PCB.

24. The multi-step pressurized switch according to claim 20, which further comprises: a protection film attached to wrap the top of the elastic plate and fixing the elastic plate on the PCB.

25. The multi-step pressurized switch according to claim 21, which further comprises: a protection film attached to wrap the top of the elastic plate and fixing the elastic plate on the PCB.

26. The multi-step pressurized switch according to claim 22, which further comprises: a frame cover settled on the protection film and combined to the PCB through both ends, preventing the elastic plate and the protection film from separation.

27. The multi-step pressurized switch according to claim 23, which further comprises: a frame cover settled on the protection film and combined to the PCB through both ends, preventing the elastic plate and the protection film from separation.

28. The multi-step pressurized switch according to claim 24, which further comprises: a frame cover settled on the protection film and combined to the PCB through both ends, preventing the elastic plate and the protection film from separation.

29. The multi-step pressurized switch according to claim 25, which further comprises: a frame cover settled on the protection film and combined to the PCB through both ends, preventing the elastic plate and the protection film from separation.
